(19) United States
(12) Patent Application Publication
(10) Pub. No.: US 2026/0311421 A1
(43) Pub. Date: Oct. 8, 2026

(54) METHOD AND DEVICE WITH RESTORATION OF THREE-DIMENSIONAL POINT MAP FROM MONOCULAR IMAGE

(71) Applicants: Samsung Electronics Co., Ltd., Suwon-si (KR); Seoul National University R&DB Foundation, Seoul (KR)

(72) Inventors: Seungyeop KANG, Seoul (KR); Sungjoo YOO, Seoul (KR)

(73) Assignees: Samsung Electronics Co., Ltd., Suwon-si (KR); Seoul National University R&DB Foundation, Seoul (KR)

(21) Appl. No.: 19/639,904

(22) Filed: Apr. 6, 2026

(30) Foreign Application Priority Data
Apr. 7, 2025 (KR) 10-2025-0044817

(51) Int. Cl. G06T 15/20; G06T 7/70

(52) U.S. Cl. CPC G06T 15/205; G06T 7/70; G06T 2207/20084

(57) ABSTRACT

A scene restoration method according to an example includes determining a canonical point map aligned with respect to a gravity direction, based on a machine learning-based scene restoration model from an input image. The scene restoration method may restore a three-dimensional (3D) point map corresponding to a specified view from the determined canonical point map.

### CROSS-REFERENCE TO RELATED APPLICATIONS

This application claims the benefit under 35 USC § 119(a) of Korean Patent Application No. 10-2025-0044817, filed on Apr. 7, 2025, in the Korean Intellectual Property Office, the entire disclosure of which is incorporated herein by reference for all purposes.

### BACKGROUND

### 1. Field

The following description relates to a technology for restoring a three dimensional (3D) point map from a monocular image.

### 2. Description of Related Art

Monocular geometry estimation may use initial hand-crafted features and CNN-based schemes, transformers and diffusion models to estimate a geometry from a monocular image. For example, depth prediction may be performed by capturing long-range (i.e., far-distance) context using a vision transformer-based encoder. As another example, zero-shot generalization may be performed using heterogeneous data and scale-invariant losses. In another example, multi-scale normalization and high-resolution processing may preserve small structures that are easily lost during downsampling. In addition, depth prediction may be improved using synthetic rendering. The robustness of prediction and an inference rate may be improved using capacity expansion of a teacher model and large-scale pseudo-labeling. Diffusion models may be restored to perform depth estimation focused on depth details in complex scenes. Variance of prediction may also be reduced by a single-step diffusion approach.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes one or more processors including processing circuitry, and memory storing instructions that, when executed by the one or more processors, cause the electronic device to: determine a canonical point map that follows a canonical coordinate system having an axis aligned with respect to a reference direction, based on a machine learning-based scene restoration model from an acquired input image, wherein when a camera acquires the input image the camera has a view that is not aligned with the reference direction, and restore, from the determined canonical point map, a three-dimensional (3D) point map corresponding to a specified view that differs from the view of the camera when it acquires the input image.

The reference direction may be a gravity direction perpendicular to the ground.

The canonical point map may include channel maps respectively corresponding to channels of the input image, and a difference between a line corresponding to points having a specified value in a channel map of the canonical point map and the reference direction is less than a threshold difference.

A coordinate system corresponding to the canonical point map and a coordinate system corresponding to the 3D point map may have a same yaw.

The instructions, when executed by the one or more processors, may further cause the electronic device to: determine, from the acquired input image, channel maps respectively corresponding to coordinate axes of the canonical point map based on the machine learning-based scene restoration model.

The scene restoration model may include a first branch network for estimating a first channel map of the canonical point map, and a second branch network for estimating a second channel map of the canonical point map, and at least one layer of the first branch network and at least one layer of the second branch network may have different parameters with respect to each other.

The instructions, when executed by the one or more processors, may further cause the electronic device to: estimate a roll rotation component and a pitch rotation component from the canonical point map, but not a yaw rotation component from the canonical point map, and transform the canonical point map into the 3D point map using the estimated roll rotation component and pitch rotation component.

The instructions, when executed by the one or more processors, may further cause the electronic device to: iteratively update transformation parameters for transformation from the canonical point map to the 3D point map, to reduce errors between image coordinates of a pixel and re-projected coordinates of the pixel in the input image.

The transformation parameters may include a scale coefficient, a shift coefficient, a roll rotation parameter, and a pitch rotation parameter.

The instructions, when executed by the one or more processors, may further cause the electronic device to: estimate a pose of the electronic device based on the restored 3D point map, generate a movement plan of the electronic device based on the estimated pose, and move the electronic device according to the generated movement plan.

In another general aspect, a scene restoration method includes determining a canonical point map that follows a canonical coordinate system having an axis aligned with respect to a reference direction, based on a machine learning-based scene restoration model from an acquired input image corresponding to a view of a camera when the camera acquired the input image, and restoring, from the determined canonical point map, a 3D point map corresponding to a specified view that differs from the view of the camera when the camera acquired the input image.

In another general aspect, a non-transitory computer-readable storage medium storing a computer program includes instructions or code that cause a computing device to: determine a canonical point map that follows a canonical coordinate system having an axis aligned with respect to a reference direction, based on a machine learning-based scene restoration model from an acquired input image, and restore a 3D point map corresponding to a specified view from the determined canonical point map.

Other features and aspects will be apparent from the following detailed description, the drawings, and the claims.

### BRIEF DESCRIPTION OF THE DRAWINGS

FIG. 1 illustrates an example of a process by which a person perceives a scene, according to one or more embodiments.

FIGS. 2 and 3 illustrate examples of estimating a three-dimensional (3D) point map using a scene restoration network, according to one or more embodiments.

FIG. 4 illustrates an example of a canonical point map, according to one or more embodiments.

FIG. 5 illustrates an example of restoring a 3D point map using a canonical point map, according to one or more embodiments.

FIG. 6 illustrates an example of a canonical point map, transformation parameters, and a 3D point map acquired from a scene restoration network, according to one or more embodiments.

FIG. 7 illustrates an example structure of a scene restoration network, according to one or more embodiments.

FIGS. 8 and 9 illustrate examples of a canonical point map, according to one or more embodiments.

FIG. 10 illustrates an example of a configuration of an electronic device, according to one or more embodiments.

Throughout the drawings and the detailed description, unless otherwise described or provided, the or like same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

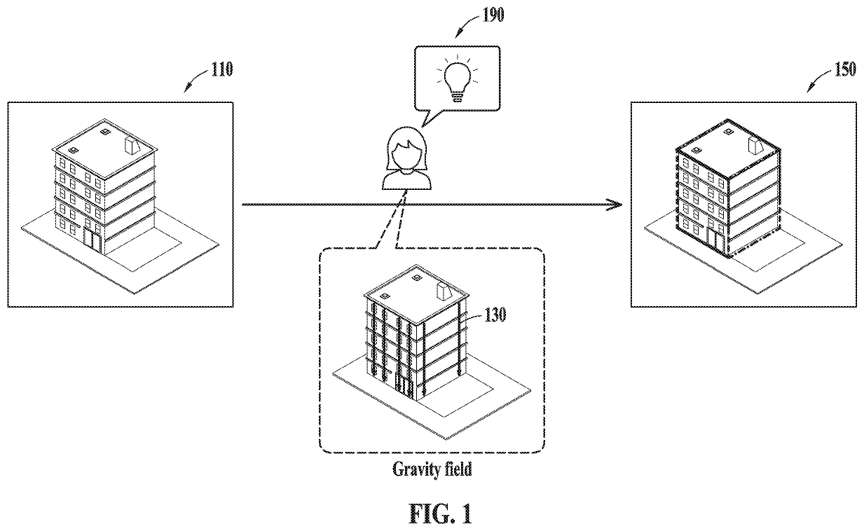

FIG. 1 illustrates an example of a process by which a person perceives a scene, according to one or more embodiments.

A scene restoration device (e.g., an electronic device) may restore data (e.g., a three-dimensional (3D) point map) representing a 3D scene with an invariant pose, and the restoring may be based on a monocular image 110. The monocular image 110 is an image captured using a single camera (i.e., not binocular or the like). Since the monocular image 110 does not include a distance (e.g., depth) to a point in a 3D space (i.e., lacks depth information), information included in the monocular image 110 is of limited use for scene restoration. For example, to supplement the limited information of the monocular image 110, the electronic device may perform a scene restoration method that is analogous to cognitive characteristics of a human 190. Through the scene restoration method, the electronic device may determine a 3D geometry of a 3D space, regardless of the influence of a camera pose.

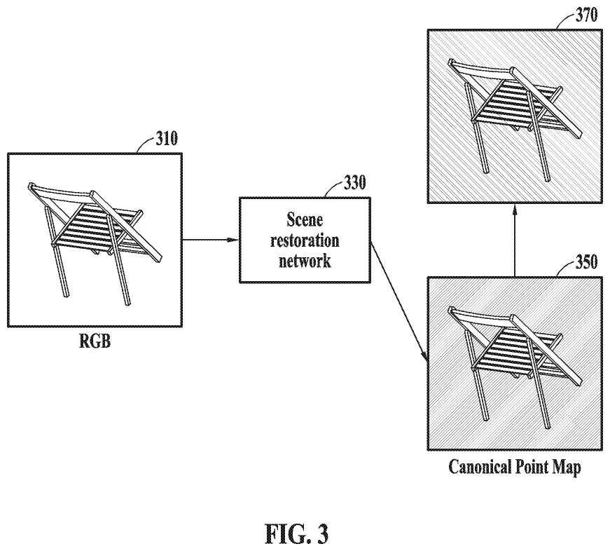

The human 190 may have a cognitive characteristic to naturally interpret the geometry in a photograph, regardless of camera orientation (e.g., a pose of the camera). The geometry may represent an overall form formed by spatially connecting and/or arranging elements of lines, surfaces, and 3D figures. For example, when viewing a building from an offset angle (e.g., not directly facing the building), the human 190 may instinctively recognize parallel edges and right-angle relationships. The human 190 may understand which lines are parallel to the ground and which lines are vertical within the geometric shape of an object. From a perspective of the human 190 standing directly on the ground, a vertical line may form a right angle to the ground. The recognition that a line perpendicular to the ground is parallel to gravity may be one of the basic ways in which the human 190 recognizes/interprets a space. The intuitive ability described above may be derived from an instinctive understanding of the human 190 that refers to gravity from various viewpoints. Due to the perceptual ability to understand a space based on gravity, the human 190 may, in a sense, mentally “restore” a 3D environment 150 from a two-dimensional (2D) image with high accuracy. The human 190 may interpret an image by referring to a gravity direction 130 implied from visual features (e.g., an exterior or a boundary line of a building) in the image, even for images captured from various angles or directions (e.g., a direction rotated 90 degrees with respect to the ground). As described with reference to FIG. 3, an electronic device may mimic the cognitive ability of the human 190 (which refers to the gravity direction 130) by generating and using a canonical point map aligned to a reference direction (e.g., the gravity direction 130).

Some of the various prior techniques may perform direct geometric prediction using affine-invariant 3D point map representation for the monocular image 110. However, since the prior techniques only refer to geometric information following a local camera frame of a camera, consistency may decrease when a shooting direction (e.g., a pose of the camera) changes. The previous techniques that estimate a pose of the camera using a single image (e.g., the monocular image 110) may use vanishing points (VPs), Manhattan world assumption, regression-based prediction of deep learning-based camera pose parameters, and prediction of intermediate cues.

However, the prior techniques described above may produce inconsistent 3D scene restorations when a camera pose is distorted or changed.

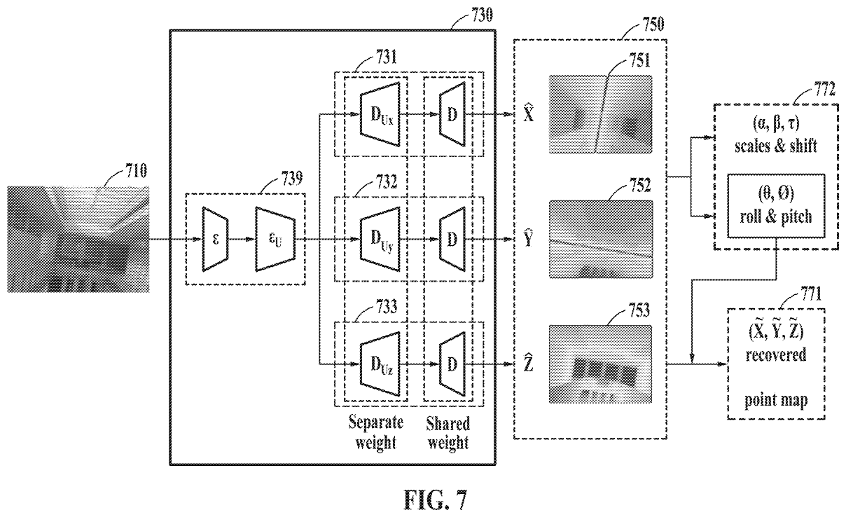

In some of the scene restoration methods described herein, the geometry and the direction of the camera may be disentangled. A scene restoration model (e.g., a scene restoration network as shown in FIG. 7) may be trained using only geometry as supervised data. Accordingly, the scene restoration network may restore data of a consistent 3D structure even for various viewpoints (e.g., various camera poses). As described above, the gravity axis in the physical world may act as a global reference, and the scene restoration network may be trained using data based on the gravity axis.

Thus, the electronic device may estimate data (e.g., a canonical point map) of a 3D scene with a consistent 3D geometry from an image (e.g., the 2D monocular image 110) based on the scene restoration network. The electronic device may estimate the pose of the camera using the canonical point map.

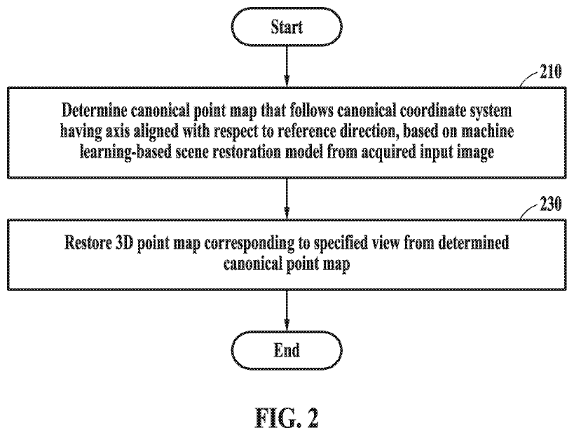

FIGS. 2 and 3 illustrate examples of estimating a 3D point map using a scene restoration network.

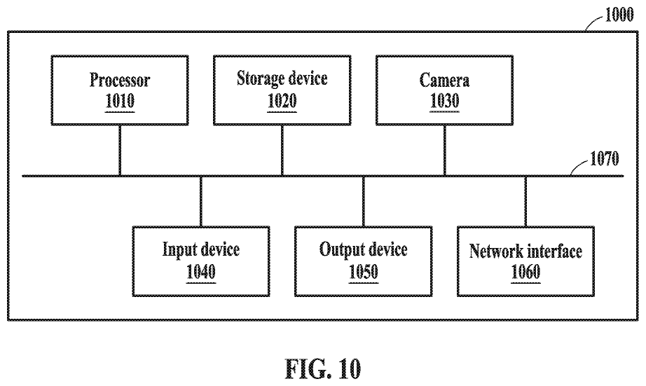

In operation 210, an electronic device may determine a canonical point map 350 based on a machine learning-based scene restoration model performing an inference on an acquired input image 310. The input image 310 may be an image captured by a camera (e.g., a camera 1030 of FIG. 10), but is not limited thereto (e.g., the image 310 may be synthetic). The electronic device may also receive an image from a separate device (e.g., an external device equipped with a camera sensor) via a communication interface.

The machine learning-based scene restoration model may be a neural network, which may be a model designed and trained to output the canonical point map 350 from the input image 310 (e.g., a 2D image). For example, the machine learning-based scene restoration model may be/include a diffusion model, which may be a diffusion-based scene restoration network 330 (e.g., the scene restoration network 330 of FIG. 3). The diffusion model may include a network (or sub-network) that destroys an image by gradually adding noise thereto, and a network (or sub-network) that restores desired data (e.g., the canonical point map 350) by removing noise. For example, the diffusion model may include a network (e.g., an encoder network) that adds noise to an input image and a network (e.g., a decoder network) that removes noise from an input image. For example, a model architecture of the scene restoration network 330 may be based on a dense prediction task adaptability of a stable diffusion model. The stable diffusion model may efficiently learn complex visual scenes with little data and generate compact latent scene representations. Through training in the latent space (e.g., training based on a loss between a ground truth latent representation and an output latent representation), parameter updates (e.g., connection weight updates between layers in a neural network) of the stable diffusion model may be quickly converged.

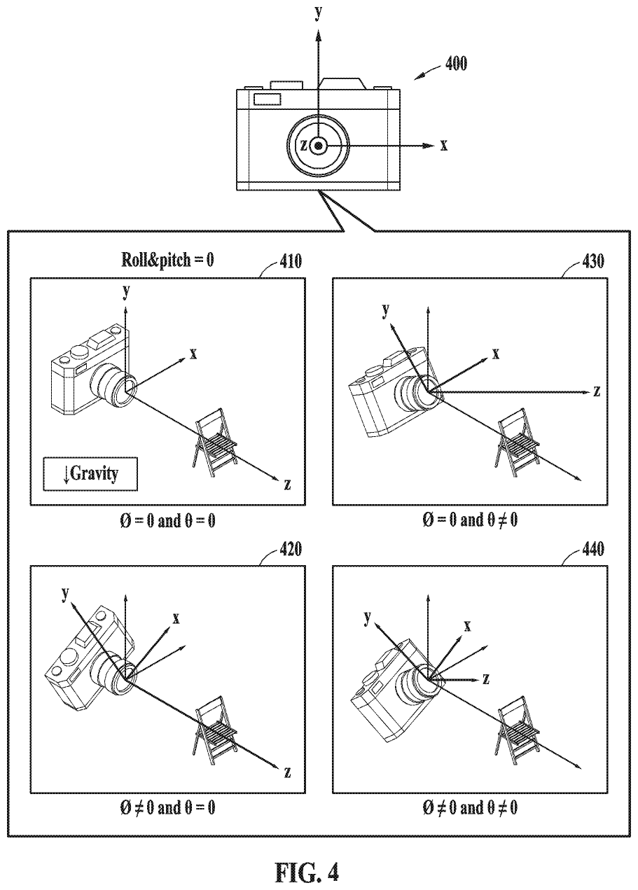

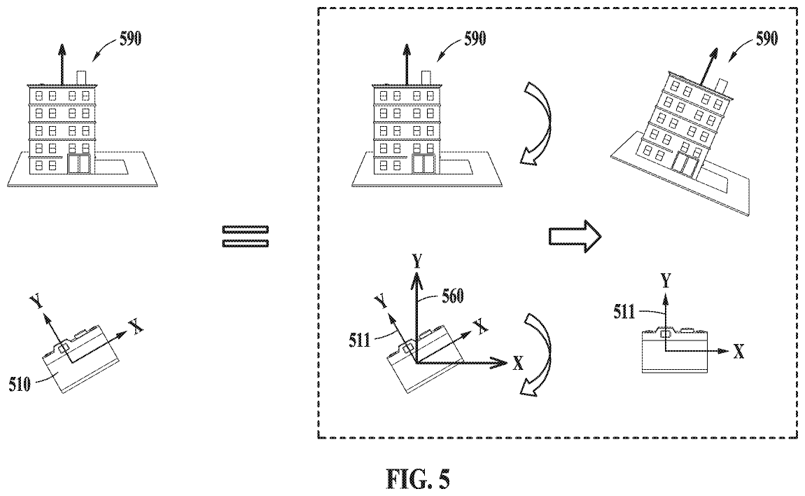

As noted, the electronic device may restore a point map from an image based on the addition and removal of noise to and from the image. A point map may represent points in a 3D space, and may express the geometry of a 3D space corresponding to a scene in the form of a point cloud. Each point of a point map may be expressed by coordinate values (e.g., (x, y, z)) that follow a specified coordinate system (e.g., a Cartesian coordinate system). The canonical point map 350 may be a point map that follows a canonical coordinate system having an axis aligned with a reference direction. For example, the reference direction may be a gravity direction, e.g., a direction perpendicular to the ground. The canonical coordinate system and the canonical point map 350 are further described with reference to FIGS. 4 and 5.

In operation 230, the electronic device may restore a 3D point map 370 corresponding to a specified view from the determined canonical point map 350. As described later, the electronic device may transform the canonical point map 350 into the 3D point map 370 of the specified view (e.g., a view corresponding to a pose of the camera) through camera pose refinement. For example, the electronic device may determine transformation parameters (e.g., roll rotation parameters and pitch rotation parameters) based on Levenberg-Marquardt (LM) optimization for the canonical point map 350, the specified view, and the input image 310. The electronic device may restore the 3D point map 370 from the canonical point map 350 using the transformation parameters. FIG. 4 illustrates an example of a canonical point map, according to one or more embodiments.

As described above, the scene restoration model (e.g., the scene restoration network of FIG. 7) may be designed and trained to output a canonical point map from an input image. The canonical point map may be a map in which 3D coordinates of points corresponding to pixels observed by a camera are expressed in a canonical coordinate system. The canonical coordinate system may be based on a canonical pose (or upright pose). A space following the canonical coordinate system may be referred to as a canonical space (or a standardized space). The canonical coordinate system may be a coordinate system in which a roll and pitch with respect to a reference plane (e.g., the ground) are set to “0”.

For example, referring to FIG. 4, an x-axis, y-axis, and z-axis of a canonical coordinate system 400 are illustrated. As described above, the y-axis of the canonical coordinate system 400 may be aligned with a gravity direction. A negative direction (e.g., −y) of the y-axis may be the downward gravity direction. For a camera in a first pose 410 (e.g., a canonical state), both a roll φ and a pitch θ are “0” with respect to the canonical coordinate system 400. For a camera in a second pose 420, the pitch θ is “0” and the roll φ is not “0” with respect to the canonical coordinate system 400. For a camera in a third pose 430, the pitch θ is not “0” and the roll φ is “0” with respect to the canonical coordinate system 400. For a camera in a fourth pose 440, both the roll φ and the pitch θ are both not “0” with respect to the canonical coordinate system 400. The roll may be an angle by which the camera is rotated around the z-axis of the canonical coordinate system 400, and the pitch may be an angle by which the camera is rotated around the x-axis.

For example, canonicalized coordinates following the camera coordinate system of the 3D points may be coordinates following the canonical space of the 3D points that are transformed using roll rotation and pitch rotation between an original camera coordinate system and the canonical coordinate system (e.g., a ground coordinate system based on the ground). As described later, the electronic device may determine coordinate information (e.g., coordinate values) following the camera coordinate system for each pose (e.g., the second pose 420, the third pose 430, and the fourth pose 440) of the camera, by applying rotation parameters (e.g., the roll parameters and/or the pitch parameters) to the coordinate information (e.g., the coordinate values) following the canonical coordinate system of each 3D point of a corresponding pixel.

For reference, the coordinate system corresponding to the canonical point map and the coordinate system corresponding to the 3D point map may have the same yaw. In terms of simulating the intuitive perception of human gravity direction, the transformation from the original camera to the canonical coordinate system may not require yaw rotation. This is because even when the camera has yaw rotation relative to the canonical coordinate system, the gravity direction applied to the points appearing in an image captured by the camera remains consistent. In other words, for camera poses having various yaws, the gravity direction will be observed in the same direction. Therefore, the yaw and position of points in the original camera coordinate system and the canonical coordinate system may be maintained. Camera coordinate systems of various poses having the same yaw and position, but with different rolls and pitches, with respect to the canonical coordinate system may be considered as sharing a same canonical state (e.g., the same pose in a canonical space).

Since the canonical coordinate system is a coordinate system in which an axis is aligned with a reference direction (e.g., a gravity direction), the canonical coordinate system may be separated from (not fully coincident with) the coordinate system of the camera (e.g., the camera coordinate system). Therefore, the canonical point map for a 3D scene may express the geometry of a scene independently of a pose of the camera rotated with respect to a non-reference axis (e.g., the x-axis or the z-axis of the canonical coordinate system 400) of the coordinate system. Regardless of a roll rotation or pitch rotation of the camera, the 3D points appearing in the scene may have consistent coordinate values in the canonical coordinate system. Therefore, the electronic device may generate a consistent canonical point map regardless of a pose transformation of the camera.

FIG. 5 illustrates an example of restoring a 3D point map using a canonical point map, according to one or more embodiments.

A camera 510 in a given pose may capture an object (e.g., a structure 590) in a physical 3D space. An electronic device according to an example may generate a canonical point map 650 according to a canonical coordinate system 560 for the object captured by the camera 510. The frame representing a canonical space included within a field of view (FOV) of the camera 510 may also be referred to as a canonical camera frame. As shown in FIG. 5, a camera coordinate system 511 and the canonical coordinate system 560 of the camera 510 may be separated (e.g., may differ in roll and/or pitch). FIG. 5 illustrates an example in which the camera coordinate system 511 is roll-rotated about a z-axis with respect to the canonical coordinate system 560. In the canonical coordinate system 560, a y-axis is aligned with gravity, and gravity may act/pull in the negative direction of the y-axis. In the example of FIG. 5, an arrow is shown that is perpendicular to the ground in a direction opposite to the direction of gravity. For example, in a canonical space, it may be ensured that the vertical structure 590 is always correctly aligned, and a horizontal plane of the structure 590 remains parallel to an xz-plane of the canonical coordinate system 560. Accordingly, even when a view of the camera 510 is tilted, the electronic device may secure a consistent 3D structure through the canonical transformation (e.g., the generation of a canonical point map) described above. That is to say, there are degrees of freedom outside of the canonical direction.

The canonical point map 650 may be transformed into a 3D point map 671 that follows a space of the original camera 510 through transformation operations (e.g., rotation transformation between the camera coordinate system 511 and the canonical coordinate system 560) described below. The electronic device may restore pose information (e.g., a pose of the camera 510) of the electronic device based on the 3D point map 671. Referring to FIG. 5, an example is illustrated in which the structure 590 expressed in an upright pose in the canonical coordinate system 560 is expressed tilted in the camera coordinate system 511.

The canonical point map 650 may provide stronger robustness than a general point map representation that varies fully with the camera pose (i.e., has freedom of rotation over all axes). As compared with a prior technique that directly infers coordinate information following the camera coordinate system 511 (e.g., a local coordinate system of the camera 510) from a monocular image, the geometry of a scene and the orientation (e.g., the pose) of the camera 510 may not be disentangled but rather may be conflated. In this case, when the camera 510 rotates in a roll or pitch manner, the structure 590 that is physically upright (e.g., a building, a pedestrian, etc.) may be represented in a tilted form in the point map. Therefore, with the prior technique, it may be difficult to train a consistent 3D structure to a machine learning-based model. Since the prior technique does not have a supervision signal that encodes the gravity direction, the 3D vision model according to the comparative example may have difficulty in implicitly learning the concept associated with the gravity direction. When the gravity direction is not considered, inconsistent 3D scenes may be reconstructed from different viewpoints, even for the same scene. Consistency may deteriorate as the camera rotations (e.g., roll and pitch rotations) become larger.

As described above, since the canonical point map 650 is independent of the roll and pitch rotation of the camera 510, a scene restoration model 630 according to an example (e.g., a scene restoration model 730 of FIG. 7) may be trained to output the 3D structure of a space in a consistent gravity direction. The canonical coordinate system 560 of the canonical point map 650 may be aligned with a gravity direction of the real world. The y-axis of the canonical coordinate system 560 may coincide with the height axis of the real world, and the remaining axes (e.g., the x-axis and the z-axis) of the canonical coordinate system 560 may be aligned parallel to the ground of the real world. Other canonical directions may be used. For example, the canonical direction may be determined independently (e.g., from the direction of a majority of parallel detected edges), or it may be set as an initial predetermined setting. Regarding the independence of the roll and pitch, this feature may be inherent. Because a vertical axis of the canonical point map is defined and inferred as parallel to a gravity axis of the real world. In other words, in the canonical point map, roll and pitch of the camera are not considered, resulting in a roll component and pitch component between the canonical map and the camera's coordinate system. For this reason, the roll rotation and the pitch rotation may be applied to the camera's coordinate system for obtaining the canonical coordinate system as shown in Equation 8.

In addition, the canonical point map 650 may be effectively inferred from visual features of an input image 610. The environment of the real world may include various visual elements containing implicit gravity cues. In an indoor environment, boundaries between ceilings, walls, and floors, doors, and furniture, and in an outdoor environment, buildings, vehicles, trees, and upright human figures may provide visual cues for recognizing the gravity direction. For example, as illustrated in FIG. 5, various objects (e.g., buildings, trees, etc.) may have visual elements that are perpendicular to the ground (e.g., the exterior wall of a building) and/or visual elements that are horizontal to the ground (e.g., the rooftop and floor of the building). Therefore, the scene restoration model 630 may be trained to output the canonical point map 650 based on only the input image 610 (although other clues may optionally also be used).

In order to facilitate understanding (by machine learning) of a canonical space, a description according to Camera Geometry Preliminaries is provided below. A relationship between coordinate information corresponding to a given image and depth map for an arbitrary 3D space (e.g., a 3D coordinate tensor following the camera coordinate system) and coordinate information following the canonical coordinate system is described.

For example, in an image Iϵ [symbol] ^{3×H×W} denotes a height of the image and W denotes a width of the image (and 3 denotes an example number of values per pixel). A depth map Dϵ [symbol] ^{H×W} corresponding to the image I may have a value (e.g., a distance value) in which a per-pixel distance of each pixel is encoded with respect to a camera's forward direction. For example, the depth map D may have values indicating distances from the camera to respective pixels in the image I. The camera coordinates P_{c}(u, v) for each pixel in an arbitrary camera coordinate space may be represented as a 3D coordinate tensor Pϵ [symbol] ^{3×H×W} (for 3D points in a space may be defined as follows).

[symbol]

$${P}_{c} ( u , v ) = [ \begin{matrix}x ( u , v ) \\ y ( u , v ) \\ z ( u , v )\end{matrix} ] \qquad Equation 1$$

In Equation 1, (u, v) are image coordinates of each pixel, which may have a normalized coordinate value. Terms x(u, v), y(u, v), and z(u, v) represent coordinate values of a point corresponding to a pixel located at the image coordinates (u, v) in the camera coordinate system. A camera-to-world transformation matrix may be defined as follows.

$${T}_{c 2 w} = [ R \vert t ] \qquad Equation 2$$

Here, R denotes a 3×3 rotation matrix, which may include parameters representing roll rotation (e.g., roll rotation parameters), parameters representing pitch rotation (e.g., pitch rotation parameters), and parameters representing yaw rotation (e.g., yaw rotation parameters). t denotes a 3×1 translation vector. Therefore, coordinates P_{cam} of a point in the camera coordinate system may be transformed into the world coordinate system according to Equation 3 below.

$${P}_{w} = R {P}_{c a m} + t \qquad Equation 3$$

In Equation 3 described above, P_{w} denotes coordinates of the 3D point P_{cam} following the camera coordinate system as transformed into the world coordinate system (e.g., a canonical coordinate system). For reference, an example of a world coordinate system in which a y-axis is aligned with gravity is mainly described herein. For example, a negative y direction follows a gravitational pull direction. However, this is to facilitate understanding, and the direction of the y-axis is not limited thereto; the positive y-axis direction may also be the gravity direction.

A scene restoration method according to some embodiments may be Pose-Invariant 3D Reconstruction (POINT3R), which may restore a scene using a canonical space considering the gravity direction, for example. With this scene restoration method, a scene may be restored according to an integrated framework in which consistent 3D reconstruction and accurate camera pose estimation are performed in parallel. A scene restoration network according to one or more embodiments may acquire geometric signals, for example, that are robust to rotations (e.g., roll and pitch rotations) that change geometric elements parallel to the gravity direction (e.g., a line perpendicular to the ground) based on supervised-learning. The scene restoration network may have improved consistency of reconstruction and accuracy of camera pose estimation.

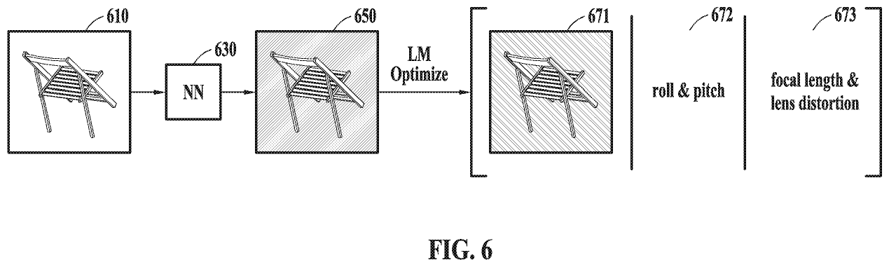

FIG. 6 illustrates the canonical point map 650, transformation parameters, and the 3D point map 671 acquired using a scene restoration network, according to one or more embodiments.

An electronic device may generate the canonical point map 650 from the input image 610 based on the scene restoration model 630 (e.g., a neural network). The canonical point map 650 may be interpreted as, for example, a result of applying inverse matrices of roll rotation parameters (e.g., roll rotation matrix) and pitch rotation parameters (e.g., pitch rotation matrix) to coordinates of the 3D point map 671 following a camera coordinate system. For example, the aforementioned rotation matrix R of Equations 2 and 3 may be factorized as shown in Equation 4 below.

$$R = {R}_{yaw} {R}_{roll} {R}_{pitch} \qquad Equation 4$$

In Equation 4, R_{yaw} denotes yaw parameters, which may be a rotation matrix with respect to a y-axis (e.g., the gravity axis) of the canonical coordinate system, Rᵣₒₗₗ denotes roll parameters, which may be a rotation matrix with respect to a z-axis of the canonical coordinate system, and R_{pitch} denotes pitch parameters, which may be a rotation matrix with respect to an x-axis of the canonical coordinate system. Through the yaw-roll-pitch factorization according to Equation 4, the influence of roll and pitch may be isolated. The pitch rotation (e.g., rotation based on the x-axis) and the roll rotation (e.g., rotation based on the z-axis) may change the direction of a gravity vector in the camera coordinate system, but the yaw rotation (e.g., rotation based on the y-axis) may not change/affect the direction of the gravity vector. As described above, the canonical coordinate system may be a coordinate system in which an axis (e.g., y-axis) is aligned with the gravity direction, and the roll and pitch may be set to “0” with respect to the world coordinate system (e.g., the ground coordinate system). The canonical coordinate system may have a yaw component and a translation component with respect to the world coordinate system. A matrix for transforming the camera coordinate system into the canonical coordinate system (e.g., a canonical rotation matrix) may be defined as expressed by Equation 5 below.

$${R}_{canonical} = {R}_{yaw} \qquad Equation 5$$

A transformation matrix T_{canonical2w} from the canonical coordinate system to the world coordinate system may be expressed by Equation 6 below.

$${T}_{canonical 2 w} = [ {R}_{yaw} \vert t ] \qquad Equation 6$$

Mapping a point (e.g., a canonical point) p_{canonical} in a canonical space (e.g., a 3D space following the canonical coordinate system) to the world coordinate system may be expressed by Equation 7 below.

$${P}_{w} = {R}_{yaw} {P}_{canonical} + t \qquad Equation 7$$

Referring to Equations 3, 4 and 7, the transformation between the canonical coordinate system and the camera coordinate system may be expressed by Equation 8 below.

$${P}_{canonical} = {R}_{roll} {R}_{p i t c h} {P}_{c a m} \qquad Equation 8$$

According to Equation 8, the canonical point p_{canonical} may be coordinates transformed by applying (e.g., matrix multiplication) a pitch rotation matrix and a roll rotation matrix to the point P_{cam} following the camera coordinate system. Therefore, the coordinates P_{canonical} of the canonical coordinate system may be coordinate values rectified by the roll and pitch rotations with respect to the original camera coordinates P_{cam}. The scene restoration network may be trained to output canonical coordinate values that consider the gravity direction implied by (or inferred from) the visual features of an image. When the camera is already aligned to the canonical coordinate system, the coordinates P_{canonical} in the canonical coordinate system and the original camera coordinates P_{cam} may be the same.

For reference, in the canonical point map 650, a floor (e.g., a plane parallel to the ground) shown in the input image 610 may have the same y coordinate values. This is because a portion corresponding to the floor has the same height from the ground. In the canonical point map 650, a vertical line (e.g., a boundary of a wall) with respect to the ground, which is parallel to gravity, may have the same x coordinate values and z coordinate values.

The electronic device may determine various transformation parameters with respect to the canonical point map 650 based on LM optimization (mentioned above). For example, the electronic device may determine rotation parameters 672 (e.g., roll parameters and pitch parameters) and additional parameters 673 (e.g., a focal length of the camera and lens distortion). The electronic device may determine the 3D point map 671 by applying the rotation parameters 672 to the canonical point map 650. The 3D point map 671 may be a map in which points in a 3D space are expressed as coordinate information following a camera coordinate system.

FIG. 7 illustrates an example structure of a scene restoration network, according to one or more embodiments.

In some embodiments, an electronic device may estimate canonical point maps 750 from an input image 710 based on the scene restoration model 730. The scene restoration model (or network) 730 may be configured and trained to predict complete 3D canonical point maps 750. The canonical point maps 750 may include channel maps (e.g., channel specific point maps). For example, the electronic device may individually generate a portion (e.g., some of the channel maps) of the canonical point maps 750 through multiple respective branch networks of the scene restoration model 730. The electronic device may determine channel maps respectively corresponding to coordinate axes of the canonical point maps 750 from the acquired input image 710, based on the machine learning-based scene restoration model 730. As illustrated in FIG. 7, the scene restoration model 730 may include a first branch network 731 for estimating a first channel map 751 of the canonical point maps 750, a second branch network 732 for estimating a second channel map 752 of the canonical point maps 750, and a third branch network 733 for estimating a third channel map 753. The first channel map 751 may represent coordinate values (e.g., x-axis coordinate values) along a first axis of the canonical point maps 750 of each point. The second channel map 752 may represent coordinate values (e.g., y-axis coordinate values) along a second axis of the canonical point maps 750 of each point. The third channel map 753 may represent coordinate values (e.g., z-axis coordinate values) along a third axis of the canonical point maps 750 of each point.

In some embodiments, at least one layer of the first branch network 731 and at least one layer of the second branch network 732 may have different parameters. Specifically, at least one layer D_{Ux} of the first branch network 731, at least one layer D_{Uy} of the second branch network 732, and at least one layer D_{Uz} of the third branch network 733, respectively, may be trained independently from the layers of other branches. That is to say, each branch may have at least one layer that is independently trained. Accordingly, the scene restoration model 730 may individually scale and shift the canonical point maps 750 respectively corresponding to the axes of the canonical coordinate system through an independent normalization strategy. Even when the scales are different for each spatial axis of the canonical coordinate system, accurate prediction of the channel map (e.g., the canonical channel map) for a corresponding axis may be possible within a prediction range (e.g., −1 or more and 1 or less) allowed in stable diffusion.

For example, the scene restoration model 730 may include an auto-encoder and a fine-tuned network (e.g., a U-net network). The auto-encoder may include a an encoder ε paired with decoder D as illustrated in FIG. 7. For reference, FIG. 7 shows a decoder D for each branch network, but the decoders D may share the same parameters (e.g., connection weights) with each other (or may be duplicates). The auto-encoder may be trained to perform mapping (e.g., ε(image)=latent value, D (latent value)=image) between an image space (e.g., RGB space) and a latent space. A fine-tunable network may be connected between the encoder ε and the decoders D of the auto-encoder.

For example, a U-net may be connected between an output layer of the encoder ε and an input layer of the decoder D. In the U-net, a layer ε_{U} connected to the encoder ε may be common to three channels. The U-net may include layers D_{Ux}, D_{Uy}, and D_{Uz} connected to the decoder D corresponding to each of a plurality of channels. The U-net may be fine-tuned with depth annotations.

For example, in the scene restoration model 730, an encoding portion 739 may include the encoder ε and a portion of layers ε_{U} of the U-net. The electronic device may be trained to determine a latent representation from the input image 710 through the encoding portion 739 of the scene restoration model 730. The determined latent representation may be propagated in common to the branch networks respectively corresponding to the channels.

The first branch network 731 may be trained to output coordinate values (e.g., an x-axis value of each point) corresponding to the first channel, which may be inferred from the latent representation provided via a portion of layers D_{Ux} of the U-net and the decoder D. The second branch network 732 may be trained to output coordinate values (e.g., a y-axis value of each point) corresponding to the second channel, which may be inferred from the latent representation provided via a portion of layers D_{Uy} of the U-net and the decoder D. The third branch network 733 may be trained to output coordinate values (e.g., a z-axis value of each point) corresponding to the third channel, which may be inferred from the latent representation provided via a portion of layers D_{Uz} of the U-net and the decoder D.

The layers ε_{U}, D_{Ux}, D_{Uy}, and D_{Uz} of the U-net described above may be fine-tuned such that the scene restoration model 730 outputs coordinate values following the canonical coordinate system of each point for independent channels (e.g., x-axis channel, y-axis channel, and z-axis channel). During the training (e.g., additional training) specifically performed for fine-tuning, parameters of the encoder ε and the decoder D may be fixed (not updated by the training), and parameters of the layers ε_{U}, D_{Ux}, D_{Uy}, and D_{Uz} of the U-net may be updated. For example, the parameters of the layers ε_{U}, D_{Ux}, D_{Uy}, and D_{Uz} of the U-net may be updated based on a latent representation loss. The latent representation loss may be based on an output (e.g., data input to the decoder D) of the U-net shown in FIG. 7. The latent representation loss may be calculated based on a latent representation map acquired from the ground truth canonical point maps 750, and the representation loss may be calculated based on (i) the encoder ε and (ii) a latent representation map output from the layers D_{Ux}, D_{Uy}, and D_{Uz} of the U-net respectively corresponding to the channels. However, an objective function for training is not limited to the above-described example. The electronic device may iteratively update the parameters (e.g., connection weights) for the fine-tuning of the intermediate layers (e.g., U-net layers) of the scene restoration model 730 until the objective function value converges.

The electronic device may perform predictions specialized for each of the x-axis, y-axis, and z-axis coordinates of the canonical coordinate system via each decoder branch (e.g., branch network) of the scene restoration model 730. The electronic device may generate the complete canonical point maps 750 by concatenating the three outputs (e.g., three channel maps).

The electronic device may estimate a roll rotation component and a pitch rotation component from the canonical point maps 750. The electronic device may iteratively update the transformation parameters 772 for transformation from the canonical point maps 750 to the 3D point map 771 such that errors between image coordinates of a pixel and reprojected coordinates of the pixel in the input image 710 are reduced. The transformation parameters 772 may include a scale coefficient, a shift coefficient, a roll rotation parameter, and/or a pitch rotation parameter. An operation of determining the transformation parameters 772 is described below.

Canonical coordinate information corresponding to an i-th pixel in the canonical point maps 750 may be expressed as (Xᵢ, Yᵢ, Zᵢ). The canonical coordinate information (Xᵢ, Yᵢ, Zᵢ) may represent coordinates of a 3D point in the canonical space. For reference, a stable diffusion-based model may be limited to a value in the range of −1 to 1. Independent normalization factors may be applied to the coordinate values corresponding to each axis. The coordinates output from the scene restoration model 730 may be determined by code configured according to Equation 9 below.

$$\hat{{X}_{i}} = {s}_{X} {X}_{i} , \hat{{Y}_{i}} = {s}_{Y} {Y}_{i} , {\hat{Z}}_{i} = {s}_{Z} {Z}_{i} + {t}_{Z} . \qquad Equation 9$$

In Equation 9, s_{X} and s_{Y} are pure scale coefficients, and no shift may be applied. For \hat{Z}, an additional shift t_{Z} may be used as well as a scale coefficient s_{Z}. (\hat{X}ᵢ, Ŷᵢ, \hat{Z}ᵢ) which is transformed according to Equation 9 may be referred to as the scale-(affine)-invariant canonical point map 750.

Perspective-n-Point (PnP)-based Levenberg-Marquardt (LM) optimization may not restore absolute scale and shift, and may only restore relative values through relative scale and shift as shown in Equation 10 below.

$$α = \frac{{s}_{X}}{{s}_{Z}} , β = \frac{{s}_{Y}}{{s}_{Z}} , τ = \frac{{t}_{Z}}{{t}_{Z}} . \qquad Equation 10$$

When the canonical point map 750 is normalized to s_{Z}, it may be determined with code configured according to Equation 11 below.

$$( {{X}^{\text{?}}}_{i} , {{Y}^{\text{?}}}_{i} , {{Z}^{\text{?}}}_{i} ) ≡ ( α {X}_{i} , β {Y}_{i} , {Z}_{i} + τ ) . \qquad Equation 11$$

$$\text{?} \text{indicates text missing or illegible when filed}$$

Since the camera translation and yaw are already reflected in the canonical point map 750, the rotation may be determined by two degrees of freedom, which are a roll φ and a pitch θ. A rotation matrix R′(θ, φ) may be factorized as shown in Equation 12 below.

$${R}^{′} = {R}_{pitch}^{- 1} {R}_{roll}^{{- 1}^{}} \qquad Equation 12$$

For reference, in Equation 12, R_{pitch}⁻¹ and Rᵣₒₗₗ⁻¹ are inverse matrices of the Rᵣₒₗₗ and R_{pitch} of Equation 8, and are expressed in terms of rotational transformation from the camera coordinate system to the canonical coordinate system. In terms of rotational transformation from the canonical coordinate system to the camera coordinate system, Equation 12 may also be expressed as R′=R′ᵣₒₗₗR′_{pitch}. The 3D point map 771 following the camera coordinate system may determine with code configured according to Equation 13 below.

$$( \begin{matrix}{\tilde{X}}_{i} \\ {\tilde{Y}}_{i} \\ {\tilde{Z}}_{i}\end{matrix} ) = {R}^{′} ( ϕ , θ ) ( \begin{matrix}{{X}^{\text{?}}}_{i} \\ {{Y}^{\text{?}}}_{i} \\ {{Z}^{\text{?}}}_{i}\end{matrix} ) \qquad Equation 13$$

$$\text{?} \text{indicates text missing or illegible when filed}$$

In Equation 1,

$$( \begin{matrix}{{X}^{\text{?}}}_{i} \\ {{Y}^{\text{?}}}_{i} \\ {{Z}^{\text{?}}}_{i}\end{matrix} )$$

$$\text{?} \text{indicates text missing or illegible when filed}$$

are coordinates of the normalized canonical point map 750.

$$( \begin{matrix}{\tilde{X}}_{i} \\ {\tilde{Y}}_{i} \\ {\tilde{Z}}_{i}\end{matrix} )$$

are coordinates transformed into a target coordinate system (e.g., a specified camera coordinate system). When a focal length is f, a 2D projection may be calculated with code configured according to Equation 14 below.

$${\hat{u}}_{i} = f \frac{{\tilde{X}}_{i}}{{\tilde{Z}}_{i}} , {\hat{v}}_{i} = f \frac{{\tilde{Y}}_{i}}{{\tilde{Z}}_{i}} . \qquad Equation 14$$

Here (uᵢ, vᵢ) are coordinates (e.g., pixel coordinates) observed in an actual image. The electronic device may update the transformation parameters 772 such that errors according to Equation 15 below are reduced and/or converges.

$$E ( α , β , τ , ϕ , θ ) = {\sum }_{i = 1}^{n} [ {( {u}_{i} - {\hat{u}}_{i} )}^{2} + {( {v}_{i} - {\hat{v}}_{i} )}^{2} ] . \qquad Equation 15$$

As described above, the transformation parameters 772 may be updated such that the sum of squared reprojection errors is reduced/minimized. For example, [symbol] may be predicted values in which pixel coordinates are transformed through a canonical coordinate system, a camera coordinate system, and then back to an image coordinate system. The electronic device may update the transformation parameters 772 such that the image coordinate values [symbol] predicted through re-projection for the i-th pixel of the image become identical or similar to [symbol] the actual image coordinate values (uᵢ, vᵢ).

LM Optimization may be used for coefficient optimization according to the above-described Equation 15. The electronic device may determine five unknowns {α, β, τ, φ, θ} using nonlinear least squares when the focal length f is fixed. The electronic device may update the transformation parameters 772 including scale, shift, roll, and pitch through an LM algorithm. In the LM algorithm, a global minimum may be secured in the process of optimization based on the reprojection error. For each iteration, the LM update may satisfy the following Equation 16.

$$( {J}^{T} J + λ D ) γ = - {J}^{T} r , \qquad Equation 16$$

In Equation 16, r denotes a residual vector, and may indicate (uᵢ, − [symbol] vᵢ− [symbol] ). J denotes a Jacobian matrix for five unknowns {α, β, τ, φ, θ}. D denotes a diagonal approximation of J^{T}J. An update vector δ may be calculated by substituting r, J, and D into the above-described equation. After calculating the update vector δ, the electronic device may update each parameter and iterate until the parameter update converges. For example, the electronic device may use δ in a previous iteration to update the parameters α, β, τ, φ, θ to {α, β, τ, φ, θ}_{new}={α, β, τ, φ, θ}_{old}+δ in a current iteration.

In a Jacobian computation, a partial differential with respect to a may be calculated as shown in Equation 17 below.

$$\frac{\partial {\hat{u}}_{i}}{\partial α} = f \frac{{X}_{i} {R}_{11} {\tilde{Z}}_{i} - {R}_{31} {X}_{i} {\tilde{X}}_{i}}{{\tilde{Z}}_{i}^{2}} . \qquad Equation 17$$

Equation 17, which represents the above-described partial differential, may be derived through the following process. First, when an element of an n-th column of an m-th row of a rotation matrix R′(θ, φ) in a projection is denoted as Rₘₙ, for the point map, a normalized point map may be expressed by Equations 18 and 19 below.

$${{X}^{\text{?}}}_{i} = {R}_{11} α {X}_{i} + {R}_{12} β {Y}_{i} + {R}_{13} ( {Z}_{i} + τ ) \qquad Equation 18$$

$${{Z}^{\text{?}}}_{i} = {R}_{31} α {X}_{i} + {R}_{32} β {Y}_{i} + {R}_{33} ( {Z}_{i} + τ ) \qquad Equation 19$$

$$\text{?} \text{indicates text missing or illegible when filed}$$

Here,

$$\frac{\partial {{u}^{\text{?}}}_{i}}{\partial α}$$

$$\text{?} \text{indicates text missing or illegible when filed}$$

may be determined by following a process such as Equation 20 below.

$$\frac{\partial {{u}^{\text{?}}}_{i}}{\partial α} = f \frac{\partial }{\partial α} ( \frac{{{X}^{\text{?}}}_{i}}{{{Z}^{\text{?}}}_{i}} ) = f \frac{{\tilde{Z}}_{i} \frac{\partial {{X}^{\text{?}}}_{i}}{\partial α} - {\tilde{X}}_{i} \frac{\partial {{Z}^{\text{?}}}_{i}}{\partial α}}{{\tilde{Z}}_{i}^{2}} . \qquad Equation 20$$

$$\text{?} \text{indicates text missing or illegible when filed}$$

Here, since

$$\frac{\partial {{X}^{\text{?}}}_{i}}{\partial α} = {R}_{11} {X}_{i} , \frac{\partial {{Z}^{\text{?}}}_{i}}{\partial α} = {R}_{31} {X}_{i} ,$$

$$\text{?} \text{indicates text missing or illegible when filed}$$

the following Equation 21 may be derived.

$$\frac{\partial }{\partial α} ( \frac{{{X}^{\text{?}}}_{i}}{{\tilde{Z}}_{i}} ) = \frac{{{Z}^{\text{?}}}_{i} ( {R}_{11} {X}_{i} ) - {{X}^{\text{?}}}_{i} ( {R}_{31} {X}_{i} )}{{{Z}^{\text{?}}}_{i}^{2}} = \frac{{X}_{i} ( {R}_{11} {{Z}^{\text{?}}}_{i} - {R}_{31} {{X}^{\text{?}}}_{i} )}{{{Z}^{\text{?}}}_{i}^{2}} . \qquad Equation 21$$

$$\text{?} \text{indicates text missing or illegible when filed}$$

By substituting Equation 21 into Equation 20, the following Equation 22 may be derived.

$$\frac{\partial {{u}^{\text{?}}}_{i}}{\partial α} = f \frac{{X}_{i} ( {R}_{11} {{Z}^{\text{?}}}_{i} - {R}_{31} {{X}^{\text{?}}}_{i} )}{{{Z}^{\text{?}}}_{i}^{2}} . \qquad Equation 22$$

$$\text{?} \text{indicates text missing or illegible when filed}$$

Partial differentials for other transformation parameters 772 may be calculated in a similar manner.

The electronic device may transform the canonical point map 750 into the 3D point map 771 using the estimated roll rotation component and pitch rotation component. For example, the electronic device may determine the restored 3D point map 771 by multiplying the canonical point map 750 by a roll rotation matrix representing the roll rotation component and a pitch rotation matrix representing the pitch rotation component.

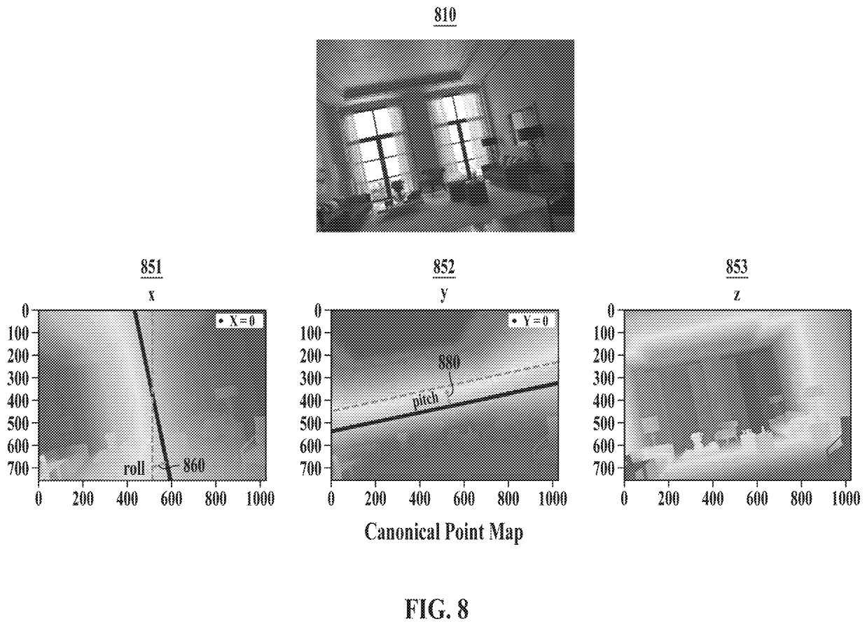

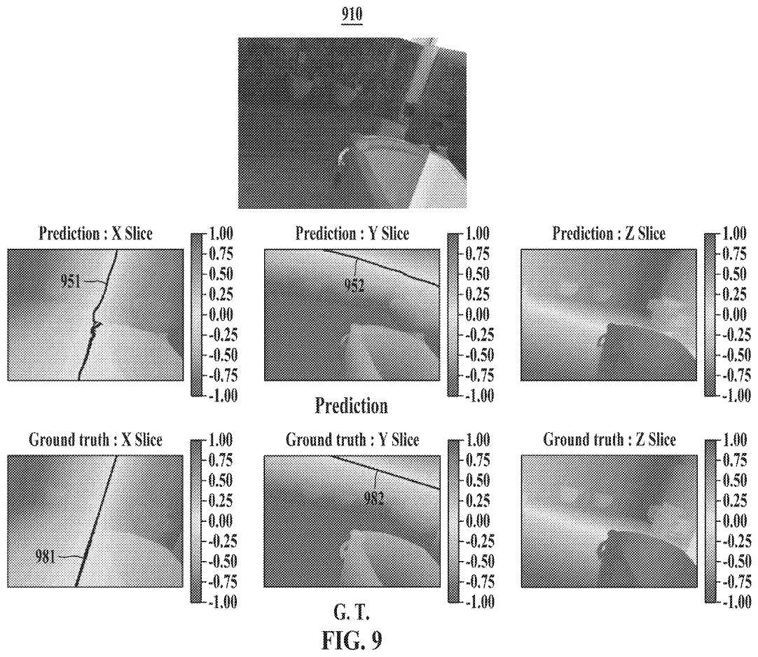

FIGS. 8 and 9 illustrate examples of a canonical point map, according to one or more embodiments.

A difference between a line corresponding to points having a specified value in a channel map of a canonical point map and a reference direction may be less than a threshold difference. For example, referring to FIG. 8, example input image 810 is an image of an indoor scene captured by a tilted camera. Therefore, a reference direction, that is, a gravity direction, may be tilted in a field of view of the camera. A reference direction to which a canonical point map is aligned, for example, a gravity direction, may be easily inferred from visual features of an image (e.g., an RGB image). For example, points located on vertical lines aligned to a gravity axis may have the same x, y values. Still referring to FIG. 8, an x-axis channel map 851, a y-axis channel map 852, and a z-axis channel map 853 are illustrated. In the x-axis channel map 851 of the canonical point map, a line where x=0 is parallel to the gravity direction and is parallel to a wall of the image. Also, a vertical line in the camera coordinate system may be rotated by a roll component of 860 with respect to the line where x=0 (e.g., a line aligned with the reference direction) in the canonical coordinate system. In addition, a y-component may be a floor or height in the real world. In the example illustrated in FIG. 8, a line corresponding to y=0 in the y-axis channel map 852 may be offset by a pitch component of 880 with respect to the line corresponding to y=0 in the camera coordinate system. Therefore, each component in the three axes may be associated with low-level visual features.

Referring to FIG. 9, with respect to an image 910, canonical point maps predicted by a scene restoration model for channel maps of the respective axes, and ground truth canonical point maps are illustrated. For example, a line corresponding to the points 951 where x=0 in the canonical coordinate system may be an approximated line for the points where x=0. Referring to FIG. 9, the points 951 where x=0 in the x-channel map may not be a perfect straight line. In addition, the approximated line for the points 951 where x=0 in the x-channel map may have an error (e.g., an angular error) less than a threshold (e.g., a threshold angle) from a line 981 at x=0 in a ground truth x-axis channel map. An error (e.g., a distance) between an approximated line for points 952 where y=0 in the y-axis channel map and a line 982 where y=0 in the y-axis channel map may be less than a threshold (e.g., a threshold distance). In brief, the above-mentioned thresholds may be used as a condition for selecting approximated lines for being processed by the relevant model.

In some implementations, the reference direction in which the canonical point map is aligned may be the gravity direction in a 3D space corresponding to the image. For example, an angular difference between the line corresponding to the points 951 where x=0 in the canonical coordinate system and the line 981 corresponding to the gravity direction in the 3D space may be less than the threshold angle. For example, the line corresponding to the points where x=0 (e.g., the approximated straight line) and the line corresponding to the gravity direction may be parallel to each other. The scene restoration model may output a canonical point map with a small error even when a camera angle deviates from a canonical state. Camera pose estimation and 3D reconstruction may be performed through a correct canonical point map.

FIG. 10 illustrates an example of a configuration of an electronic device, according to one or more embodiments.

Referring to FIG. 10, an electronic device 1000 is a device that restores 3D scene data (e.g., a 3D point map) from an input image (e.g., a 2D image) using the scene restoration methods described above. The electronic device 1000 may be, for example, an image processing device, a smartphone, a wearable device, a tablet computer, a netbook, a laptop, a desktop, a personal digital assistant (PDA), a vehicle (e.g., an autonomous vehicle), or a robot (e.g., an autonomous humanoid robot).

Referring to FIG. 10, the electronic device 1000 may include a processor 1010, a storage device 1020, a camera 1030, an input device 1040, an output device 1050, and a network interface 1060. The processor 1010, the storage device 1020, the camera 1030, the input device 1040, the output device 1050, and the network interface 1060 may communicate with each other via a communication bus 1070.

The processor 1010 may include processing circuitry that executes functions and instructions (or code) to execute within the electronic device 1000. In practice, the processor 1010 may be one or more processors, possibly heterogenous. For example, the processor 1010 may process instructions stored in the storage device 1020. The processor 1010 may perform one or more of the operations described above with reference to FIGS. 1 to 9.

The storage device 1020 stores information or data for execution of the processor 1010. The storage device 1020 may include a computer-readable storage medium or a computer-readable storage device. The storage device 1020 may store instructions or code to be executed by the processor 1010 and may store related information while software or an application is executed by the electronic device 1000. For example, the storage device 1020 may store a scene restoration model (e.g., the scene restoration model 730 of FIG. 7).

The camera 1030 may capture an input image. The input image may be a monocular image (or a single image) corresponding to one view of a camera. The image captured by the camera 1030 may be used to determine a canonical point map and a 3D point map. However, without limitation, the camera 1030 may also capture images of temporally and/or spatially different views. The processor 1010 may estimate the canonical point map described above with reference to FIGS. 1 to 9 for each of a plurality of images based on the scene restoration model, and may restore a 3D point map using the estimated canonical point map. The electronic device 1000 may also generate a more accurate point map based on the 3D point maps determined from the plurality of images.

The input device 1040 may receive an input from a user via a tactile, video, audio, or touch input. The input device 1040 may include a keyboard, mouse, touch screen, microphone, or any other device capable of detecting an input from a user and transmitting the detected input.

The output device 1050 may provide an output of the electronic device 1000 to a user via a visual, auditory, or tactile channel. The output device 1050 may include, for example, a display, a touch screen, a speaker, a vibration generating device, or any other device capable of providing an output to a user. The network interface 1060 may communicate with an external device through a wired or wireless network. The network interface 1060 may also receive an image from the external device.

In an example, the electronic device 1000 may control an operation of the electronic device 1000 using the canonical point map and/or the 3D point map determined with reference to FIGS. 1 to 9. For example, the electronic device 1000 may estimate a pose of the electronic device 1000 based on the restored 3D point map. In implementations where the electronic device 1000 is mounted on a moving device (e.g., a vehicle, drone, robot, or the like), the electronic device 1000 may generate a movement plan of the electronic device 1000 based on the estimated pose. The movement plan may be generated based on a 3D point map representing a surrounding environment of the electronic device 1000. The electronic device 1000 may move the electronic device 1000 according to the generated movement plan by controlling movement of the moving device. When the electronic device 1000 is an autonomous vehicle or a robot, the electronic device 1000 may move by operating a driving unit (e.g., a motor, a power transmission structure connected to the motor, and wheels). The electronic device 1000 may detect an environment in real time through a sensor (e.g., a camera sensor) while moving and adjust a plan. The electronic device 1000 may steer, accelerate, and/or brake according to the movement plan.

A canonical point map representation may provide consistent 3D reconstruction regardless of roll and pitch rotations of the camera. Unlike existing 3D point map schemes, the scene restoration model according to an example may provide information that disentangles camera orientation and geometry by representing a scene in a space aligned with a gravity axis. A canonical point map may be advantageous for training a deep neural network compared to an existing point map. This is because the canonical point map maintains a consistent and physically explained geometry. On the other hand, a prior type of point map (e.g., non-canonical) may be conflated with the camera orientation.

The computing apparatuses, the vehicles, the electronic devices, the processors, the memories, the image sensors/cameras, the displays, the information output system and hardware, the storage devices, and other apparatuses, devices, units, modules, and components described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-10 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device, comprising:
one or more processors comprising processing circuitry; and
memory storing instructions that, when executed by the one or more processors, cause the electronic device to:
determine a canonical point map that follows a canonical coordinate system having an axis aligned with respect to a reference direction, based on a machine learning-based scene restoration model from an acquired input image, wherein when a camera acquires the input image the camera has a view that is not aligned with the reference direction, and
restore, from the determined canonical point map, a three-dimensional (3D) point map corresponding to a specified view that differs from the view of the camera when it acquires the input image.

2. The electronic device of claim 1, wherein the reference direction is a gravity direction perpendicular to the ground.

3. The electronic device of claim 1, wherein the canonical point map comprises channel maps respectively corresponding to channels of the input image, and wherein a difference between a line corresponding to points having a specified value in a channel map of the canonical point map and the reference direction is less than a threshold difference.

4. The electronic device of claim 1, wherein a coordinate system corresponding to the canonical point map and a coordinate system corresponding to the 3D point map have a same yaw.

5. The electronic device of claim 1, wherein the instructions, when executed by the one or more processors, further cause the electronic device to:
determine, from the acquired input image, channel maps respectively corresponding to coordinate axes of the canonical point map based on the machine learning-based scene restoration model.

6. The electronic device of claim 1, wherein the scene restoration model comprises:
a first branch network for estimating a first channel map of the canonical point map, and
a second branch network for estimating a second channel map of the canonical point map,
wherein at least one layer of the first branch network and at least one layer of the second branch network have different parameters with respect to each other.

7. The electronic device of claim 1, wherein the instructions, when executed by the one or more processors, further cause the electronic device to:
estimate a roll rotation component and a pitch rotation component from the canonical point map, but not a yaw rotation component from the canonical point map, and
transform the canonical point map into the 3D point map using the estimated roll rotation component and pitch rotation component.

8. The electronic device of claim 1, wherein the instructions, when executed by the one or more processors, further cause the electronic device to:
iteratively update transformation parameters for transformation from the canonical point map to the 3D point map, to reduce errors between image coordinates of a pixel and re-projected coordinates of the pixel in the input image.

9. The electronic device of claim 8, wherein the transformation parameters comprise:
a scale coefficient, a shift coefficient, a roll rotation parameter, and a pitch rotation parameter.

10. The electronic device of claim 1, wherein the instructions, when executed by the one or more processors, further cause the electronic device to:
estimate a pose of the electronic device based on the restored 3D point map,
generate a movement plan of the electronic device based on the estimated pose, and
move the electronic device according to the generated movement plan.

11. A scene restoration method performed by one or more processors, the scene restoration method comprising:
determining a canonical point map that follows a canonical coordinate system having an axis aligned with respect to a reference direction, based on a machine learning-based scene restoration model from an acquired input image corresponding to a view of a camera when the camera acquired the input image, and
restoring, from the determined canonical point map, a three-dimensional (3D) point map corresponding to a specified view that differs from the view of the camera when the camera acquired the input image.

12. The scene restoration method of claim 11, wherein the reference direction is a gravity direction perpendicular to the ground.

13. The scene restoration method of claim 11, wherein the canonical point map comprises channel maps respectively corresponding to channels of the input image, and wherein a difference between a line corresponding to points having a specified value in a channel map of the canonical point map and the reference direction is less than a threshold difference.

14. The scene restoration method of claim 11, wherein a coordinate system corresponding to the canonical point map and a coordinate system corresponding to the 3D point map have a same yaw.

15. The scene restoration method of claim 11, wherein the determining of the canonical point map comprises:
determining, from the acquired input image, channel maps respectively corresponding to coordinate axes of the canonical point map based on the machine learning-based scene restoration model.

16. The scene restoration method of claim 11, wherein the scene restoration model comprises:
a first branch network for estimating a first channel map of the canonical point map, and
a second branch network for estimating a second channel map of the canonical point map,
wherein at least one layer of the first branch network and at least one layer of the second branch network have different parameters with respect to each other.

17. The scene restoration method of claim 11, wherein the restoring of the 3D point map comprises:
estimating a roll rotation component and a pitch rotation component from the canonical point map, but not a yaw rotation component from the canonical point map, and
transforming the canonical point map into the 3D point map using the estimated roll rotation component and pitch rotation component.

18. The scene restoration method of claim 11, wherein the restoring of the 3D point map comprises:
iteratively updating transformation parameters for transformation from the canonical point map to the 3D point map, to reduce errors between image coordinates of a pixel and re-projected coordinates of the pixel in the input image.

19. The scene restoration method of claim 18, wherein the transformation parameters comprise:
a scale coefficient, a shift coefficient, a roll rotation parameter, and a pitch rotation parameter.

20. A non-transitory computer-readable storage medium storing a computer program including instructions that cause a computing device to:
determine a canonical point map that follows a canonical coordinate system having an axis aligned with respect to a reference direction, based on a machine learning-based scene restoration model from an acquired input image, and
restore a three-dimensional (3D) point map corresponding to a specified view from the determined canonical point map.
